(19) United States
(12) Patent Application Publication
(10) Pub. No.: US 2026/0187166 A1
(43) Pub. Date: Jul. 2, 2026

(54) Method and System for Linking Media Content

(71) Applicant: Spotify AB, Stockholm (SE)

(72) Inventors: Sravana K. Reddy, Somerville, MA (US); Brian Regan, London (GB); Katarzyna Drzyzga, London (GB); Mike Sereiko, New York, NY (US)

(21) Appl. No.: 19/003,104

(22) Filed: Dec. 27, 2024

(51) Int. Cl. G06F 16/9535; G06F 40/20

(52) U.S. Cl. CPC G06F 16/9535; G06F 40/20

(57) ABSTRACT

A method and system for linking media content. An example method includes a computing system obtaining a key term from a first media-content item. Further, the method includes the computing system identifying one or more candidate matches for the obtained key term. In addition, the method includes, for at least one identified candidate match, the computing system determining whether the candidate match is a match for the key term, with the determining including (i) determining a level of similarity between the first media-content item and one or more second media-content items associated with the candidate match and (ii) using a trained machine-learning model to validate the candidate match, based on at least the determined level of similarity and a set of features characteristic of matching. Still further, the method includes, based on the validating of the candidate match, the computing system establishing a link corresponding with the match.

### TECHNICAL FIELD

The present disclosure relates to the field of digital audio content and, more specifically, to automated correlation and linking of media content.

### BACKGROUND

A representative multimedia platform may host various types of media content for presentation to users. One type of media content that has gained great popularity in recent years is podcasts. A podcast is a digital audio program or show, typically consisting of a series of episodes available for download or streaming over the internet, allowing on-demand access similar to radio shows but giving listeners the flexibility to listen at their convenience. The term “podcast” may also refer to a particular episode of a given podcast show. Further, while podcasts have traditionally been audio-only, video podcasts, including both video and audio content, have also been growing in popularity.

### SUMMARY

There are now many millions of podcasts, with the number of podcasts continuing to grow. Further, there are now also many millions of other types of media content such as audiobooks, music, videos, and games. From a user-experience perspective, it would be useful for a media-streaming platform to link podcasts with other media content, such as audiobooks, music, videos, games, or other podcasts. In particular, it would be worthwhile for such a platform to link specific podcasts with such other media content based on the podcasts including discussion that relates to the other media content. For instance, if a podcast includes discussion about a particular audiobook, it would be worthwhile for the platform to link that podcast with that audiobook, to allow a consumer of the podcast to readily access the audiobook or vice versa. Likewise, if a podcast includes a discussion about a particular audiobook author, it would be worthwhile for the platform to link that podcast with one or more audio books by that author, to allow a consumer of the podcast to readily access each such audio book or vice versa.

Unfortunately, however, with so many podcasts, it may be technically challenging to accurately create these links. In particular, it may be technically difficult for a computing system to accurately determine which podcasts include discussion related to which other media content.

By way of example, one way for a computing system to create these links may be for the system to programmatically search for podcasts that have metadata matching metadata of other media content and to create links based on the search results. For instance, as to an audiobook by the author “J. T. Kestrel,” the computing system may search for podcasts with metadata that includes the term “J. T. Kestrel” and may link any such podcasts with the audiobook. However, this process may be very error prone, possibly under-inclusive due to name variants (e.g., “John T. Kestrel”) or misspellings (e.g., ‘John T. Kestral”), or possibly over-inclusive in situations where a mention of the author name is not a core point of the podcast, such as where a podcast's metadata mentions “JT Kestrel” in passing but where JT Kestrel is not a guest or other subject of the podcast, where a podcast's metadata mentions someone else with the same or similar name.

An improved technique to link podcasts with other media content would therefore be desirable. More generally, an improved technique to link various types of media content and/or attributes of media content, such as linking a podcast to an audiobook author identifier, linking an audiobook to a performing artist identifier, or linking a podcast episode to a musical track, among other possibilities.

As a non-limiting example, the present disclosure provides a mechanism to facilitate creating links between podcasts and other media content, such as but not limited to audiobooks, music, videos, games, or other podcasts, based on the podcasts including discussion related to the other media content. Further, the disclosed mechanism facilitates doing this at scale, possibly given thousands or millions of podcasts and other media content.

Without limitation, this mechanism could facilitate creating links between podcasts and audiobooks based on podcast guests being authors of the audiobooks. For instance, the mechanism may facilitate creating a link between a given podcast and an audiobook by a given author, based on the author being interviewed on the podcast. Similar principles could also apply to creating links between podcasts and audiobooks based on the podcasts containing reviews of audiobook titles, and creating links to other media content based on associated key features.

The disclosed mechanism may involve a computing system applying a series of trained machine-learning (ML) models, first to extract a key term discussed in a podcast and then to match the extracted key term with other media content such as an audiobook. For instance, this may involve applying multiple trained ML models to extract from a podcast episode the name of a guest of the podcast episode and to then match that extracted guest name to an author name in a catalog of audiobook authors.

Further, the disclosed mechanism may then involve, based on the matching, the computing system creating a link between the podcast episode and one or more audiobooks having that matched author name. For instance, the mechanism may involve creating a link to an author record that in turn links to one or more audiobooks by that author, or more directly creating a link to an audiobook by that author. The mechanism may then involve providing that link in relation to the podcast episode, so that a user accessing the podcast episode can readily navigate to one or more audiobooks by the author who is a guest on the podcast episode.

The process of extracting a key term (e.g., guest name) from a podcast episode may involve the computing system recognizing a set of candidate key terms (i.e., one or more key terms) (e.g., names) in the podcast episode and then filtering/verifying the set of candidate key terms based on various features, so as to establish a resulting set of one or more key terms of relevance. In an example implementation, the act of recognizing the set of key terms may involve the computing system applying a trained large language model (LLM), and the act of filtering/verifying the set of candidate key terms based to establish a resulting set of one or more key terms may then involve applying, in series, an LLM and a classifier.

As to the filtering/verifying process in particular, if the goal is to identify podcast guests (e.g., as opposed to podcast hosts or names mentioned in podcasts), the process may involve, for each candidate name recognized in the podcast episode, (a) applying an LLM to text associated with the podcast episode (e.g., transcript, show/episode name, show/episode description, etc.) in combination with the candidate name, so as to output a confidence score indicating confidence that the candidate name is a guest, and then (b) applying a trained random-forest classifier to determine with higher confidence whether a candidate name is a guest.

Application of the trained random-forest classifier could be based on the confidence score along with additional features that can help to determine whether a candidate name is a guest of the podcast episode. These additional features may include features related to the podcast show of which the episode is a part (such as length of the show, average number of guests per episode in the show, and number of episodes in the show). Further, the additional features may include features related to the episode itself (such as length of the episode, and the title and description of the episode). Still further, the additional features may include features related to the candidate guest name (such as number of times that guest appears in all episodes of the show, whether the guest name is in the episode name, the show name, or the show description (e.g., within the first 1000 characters of the show description), and the number of podcast shows with the guest name as a guest.) A resulting set could then be one or more names that the random-forest classifier predicts with high enough certainty to each be a name of the guest of the podcast episode.

As to each such key term (e.g., guest name) extracted from a podcast episode, the process of the computing system then matching that extracted key term with other media content, such as finding that a podcast guest is an audiobook author may then involve the computing system recognizing a set of candidate matches of the extracted key term with key terms of such other media so as to establish a set of candidate matches, and the computing system then disambiguating or filtering to identify matches that would be deemed to be of relevance.

In an example implementation, the act of recognizing the set of candidate matches may involve the computing system applying fuzzy-name matching (possibly with a trained LLM) or the like to match the key term of the podcast episode with key terms of other media such as audiobooks so as to establish a set of candidate matches. For instance, if the goal is to identify one or more audiobook author names that match a given podcast guest name, this process may involve normalizing the podcast guest name (e.g., removing a name title, and identifying first, middle, and last name) and then applying fuzzy-name matching of the normalized guest name with known names of audiobook authors in an author catalog, to identify a set of candidate audiobook author names that may match the podcast guest name.

The act of disambiguating or filtering to identify matches of relevance may then usefully involve applying, in series, a deep learning model and a classifier. For instance, if the goal is to identify audiobooks authors matching a given podcast guest name, this process may involve, for each candidate author name, (a) applying a deep learning model to establish vector embeddings of a description of the podcast episode and a description of each of one or more audiobooks having that author, and determining similarity between those embeddings, so as to output an embedding-similarity score between the podcast episode and one or more audiobooks by the author, and then (b) applying an ensemble learning method such as a trained random-forest classifier to determine with higher confidence whether a candidate author is a match.

Application of the trained random-forest classifier could be based on the embedding-similarity score along with additional features that can help to determine whether a candidate name as it exists in the podcast episode is an audiobook author. For instance, these additional features could include (i) whether the podcast episode includes a mention of a book that is known to have the candidate author name as its author name, (ii) whether the podcast episode includes a mention of the term “book” even generally, (iii) how many episodes of the podcast show have had book authors as guests, (iv) how many audiobooks the candidate author has, possibly limited based on popularity and/or recency, among other possibilities, and (v) exactness (e.g., certainty) of the fuzzy-name matching.

Accordingly, in one respect, disclosed is a method. The example method includes a computing system obtaining a key term from a first media-content item. Further, the method includes the computing system identifying one or more candidate matches for the obtained key term. In addition, the example method includes, for at least one identified candidate match, the computing system determining whether the candidate match is a match for the key term, with the determining including (i) determining a level of similarity between the first media-content item and one or more second media-content items associated with the candidate match and (ii) using a trained machine-learning model to validate the candidate match, based on at least the determined level of similarity and a set of features characteristic of matching. Still further, the example method includes, based on the validating of the candidate match, the computing system establishing a link corresponding with the match.

In yet another respect, disclosed is a computing system including at least one processor, non-transitory data storage, and program instructions stored in the non-transitory data storage and executable by the at least one processor to cause the computing system to carry out operations such as those in the example method for instance.

Still further, in another respect, disclosed is non-transitory data storage (e.g., one or more instances of computer-readable storage) having stored program instructions executable by at least one processor of a computing system to cause the computing system to carry out operations such as those in the example method for instance.

Yet further, in still another respect, disclosed is a computer program comprising program instructions executable by at least one processor of a computing system to carry out operations such as those in the example method for instance.

In addition, in another respect, disclosed is a system including various means for carrying out operations such as those in the example method for instance.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a simplified block diagram of a media content delivery system, in accordance with example embodiments.

FIG. 2 is a simplified block diagram of an electronic device, in accordance with example embodiments.

FIG. 3 is a simplified block diagram of a media content server, in accordance with example embodiments.

FIG. 4 is a simplified block diagram of an example computing system, in accordance with example embodiments.

FIG. 5 is a simplified illustration of a relational database structure holding interrelated records in accordance with example embodiments.

FIG. 6 is a processing-flow diagram illustrating example processing to find that a podcast guest is an audiobook author.

FIG. 7 is a simplified illustration of a GUI showing how a podcast may link with an audiobook author and/or with one or more books by the author.

FIG. 8 is a flow chart, in accordance with example embodiments.

FIG. 9 is another flow chart, in accordance with example embodiments.

### DETAILED DESCRIPTION

Example methods, devices, and systems are described herein. It should be understood that the word “example” or “exemplary” to the extent used herein means “serving as a possible instance or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, any separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Still further, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

In addition, unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### Example System and Device Architecture

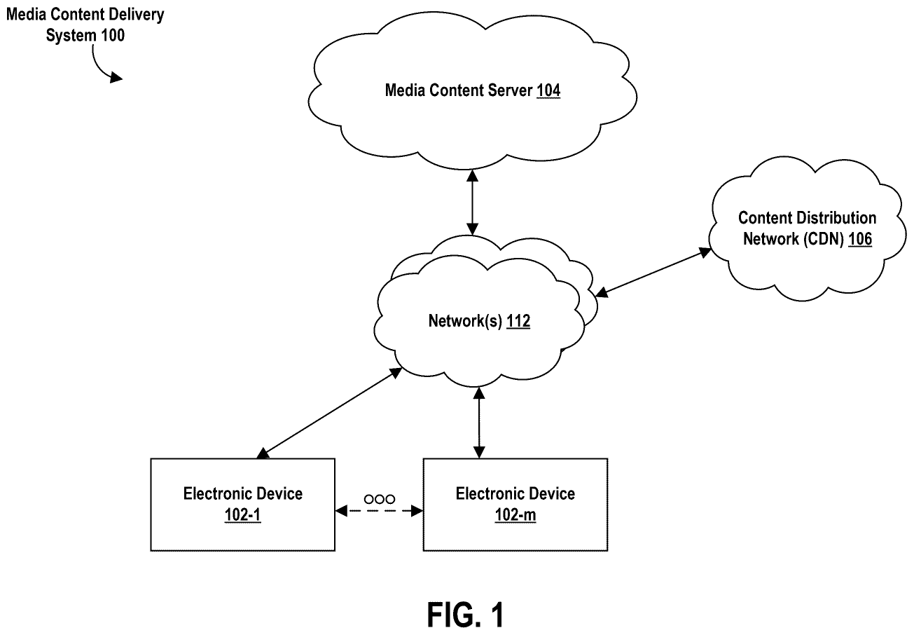

FIG. 1 is a simplified block diagram illustrating an example media content delivery system 100. The example media content delivery system 100 includes one or more electronic devices 102 (e.g., electronic device 102-1 to electronic device 102-m, where m is an integer greater than one), at least one media content server 104, and at least one content distribution network (CDN) 106. With this arrangement, the media content server 104 may be configured to stream or otherwise provide media content items, possibly through the CDN 106, for receipt and playout by the electronic devices 102.

Media content items (also referred to as “media content”, “content”, “media items”, and “content items”) may take various forms. For instance, the media content items may include audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2D or 3D graphics-based computer games, etc.), web pages, and/or any combination of these and/or other types of content. In some embodiments, media content items may include one or more audio media content items, such as particular songs, podcasts, or audiobooks, that may also be referred to as “audio content items”, “audio items,” “tracks,” and/or “audio tracks”.

As shown, one or more networks 112 may communicatively couple the components of the media content delivery system 100. The one or more networks 112 may include public communication networks, private communication networks, or a combination of both public and private communication networks. For example, the one or more networks 112 could include one or more wide area networks (WANs) such as the Internet, a cellular network, and/or a satellite communication network, and/or could include one or more local area networks (LAN), virtual private networks (VPN), metropolitan area networks (MAN), peer-to-peer networks, mesh networks, and/or ad-hoc connections, among other possibilities.

Example electronic devices 102, which may be associated respectively with one or more users, may take various forms. For instance, an electronic device 102 could be a personal computer, a mobile electronic device, a wearable computing device, a laptop computer, a tablet computer, a mobile phone, a feature phone, a smartphone, an infotainment system, a digital media player, a gaming device, a speaker, a television (TV), and/or any other electronic device capable of playing and/or presenting media content (e.g., controlling playback of media items, such as music tracks, podcasts, videos, etc.) Alternatively, the electronic device 102 may be a component of another system such as a home entertainment system, a radio/alarm clock, or an infotainment system of a vehicle, for instance, and may enable that system to play media content.

In some embodiments, the electronic devices 102 may be the same type of device as each other (e.g., electronic device 102-1 and electronic device 102-m may both be speakers). In other embodiments, the electronic devices 102 may include two or more different types of devices.

The example electronic devices 102 may also be configured to communicate with each other through direct or networked communication links, represented by the dashed arrow in FIG. 1, which may include wireless and/or wired connections. For instance, the electronic devices 102 may communicate with each other through a direct wired connection such as a High Definition Multimedia Interface (HDMI) connection, or through a direct wireless communication such as short or medium range wireless signaling using technologies such as BLUETOOTH, BLUETOOTH LOW ENERGY (BLE), ZIGBEE, WI-FI, WIRELESSHART, Near Field Communication (NFC), Radio Frequency Identification (RFID), infrared, Thread, Z-Wave, MiWi, Low-Rate Wireless Personal Area Network (LR-WPAN), or Internet Protocol v. 6 (IPv6) over WPAN (6oWPAN), among other possibilities. Alternatively or additionally, the electronic devices 102 may communicate with each other through one or more networks (perhaps one or more of network(s) 112), such as through a wireless mesh network, a LAN, a cellular network, or other form of network. Through these inter-device connections, one electronic device 102-1 may stream or otherwise transmit media content to another electronic device 102-m to facilitate playout of the media content.

An example electronic device 102 may be configured to play media content items, outputting the associated media content for presentation to a user and/or outputting the associated media content through an inter-device connection to another electronic device for presentation to a user.

The electronic device 102 may obtain these media content items from local data storage and/or through transmission from the media content server 104, CDN 106, or other device or system. For instance, the electronic device 102 may include or otherwise have access to local data storage containing some of these media content items and may be configured to retrieve the media content items from that local data storage and to play out the retrieved media content items. Further the electronic device 102 may be configured to interwork with the media content server 104 to cause the media content server 104 to stream, progressively download, and/or otherwise transmit media content items to the electronic device 102, and the electronic device 102 may be configured to receive and play out those transmitted media content items as well. In some cases, an example electronic device 102 may also be configured to transmit to the media content server 104 indications of media content items, possibly the media content items themselves, for various purposes.

To facilitate playout of media content items, the example electronic device 102 may be programmed with a media application. The media application may provide a user interface (e.g., a graphical user interface (GUI)) through which a user of the electronic device 102 can control playing of media content items, and the media application may include a media-playback engine configured to obtain and play out media content items in response to user control commands and/or other triggers.

For instance, the media application may receive a user's control commands related to playout of media content items, such as requests to play particular media content items or playlists of media content items and commands to pause or stop media playout, to adjust volume, or to jump to a next track or a previous track, among other possibilities. And the media application may be configured to respond to those commands by engaging in associated control signaling with the media content server 104 to control streaming or other transmission of media content items from the media content server 104 to the electronic device 102 and/or by engaging in associated control of playing out media content items from local data storage.

An example media content server 104 may be configured to receive media commands or other requests from electronic devices 102 and to respond accordingly. To facilitate this, in some embodiments, the media content server 104 may provide an application programming interface (API), such as a voice API or a connect API, accessible by one or more of the electronic devices 102. The media content server 104 may also be configured to validate (e.g., authenticate) electronic devices 102 using a key service for example, such as by exchanging one or more keys (e.g., tokens) with the electronic device 102.

The example media content server 104 may include or otherwise have access to data storage storing media content items available for transmission to electronic devices 102, as well as playlists each defining a sequence or other set of media content items for playout. Playlists may be defined by users of the electronic devices 102, by editors associated with media-providing services, and/or by machine-based processes, among other possibilities. The media content server 104 may also be configured to provide electronic devices 102 with information about the available media content items and playlists, such as web pages or other interfaces presenting the information, to enable users of the electronic devices 102 to obtain this information and to correspondingly control media playout.

Further, in some implementations, the media content server 104 may interwork with the one or more CDNs 106 to facilitate management and transmission of media content items and associated information to the electronic devices 102. For instance, a CDN 106 may cache media content items, playlists, and associated data and may be configured to transmit this data to electronic devices 102 through the network(s) 112 in response to requests from the electronic devices 102.

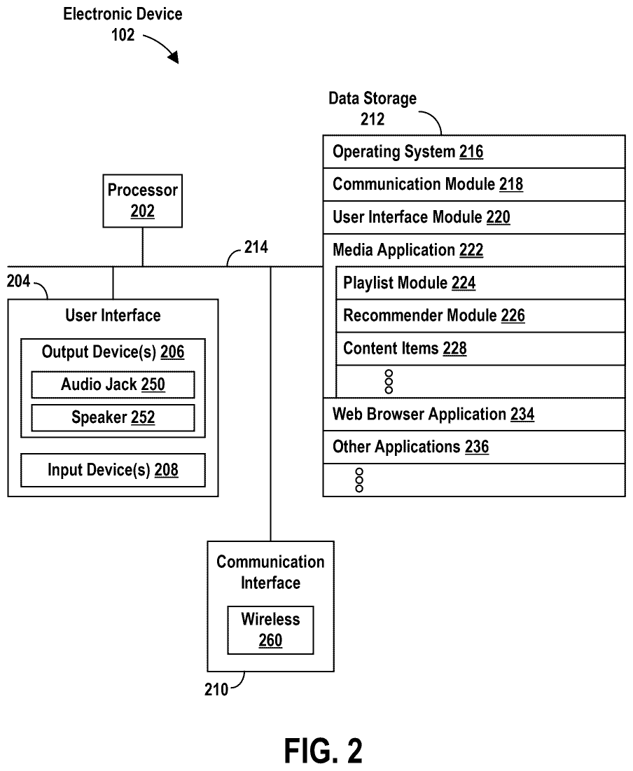

FIG. 2 is a simplified block diagram illustrating an example electronic device 102. As shown in FIG. 2, the example electronic device 102 includes a processor 202, a user interface 204, a communication interface 210, and non-transitory data storage 212, any or all of which may be integrated together to various extents and/or communicatively linked with each other by a system bus, network, or other connection mechanism 214, on a chipset or other integrated circuit, among other possibilities.

The processor 202 may include one or more general purpose processors (e.g., microprocessors) and/or one or more specialized processors (e.g., digital signal processors (DSPs), graphics processing units (GPUs), neural processing units (NPUs), etc.)

The user interface 204 may include one or more output devices 206 and one or more input devices 208 to facilitate interaction with a user. Example output devices 206 may include audio output devices such as an audio jack 250, a sound speaker 252, and/or another port, interface, or the like for connecting with speakers, earbuds, headphones, and/or other listening devices, and video output devices, such as a display panel for instance. Further, example input devices 208 may include an audio input device such as a microphone and other types of user input mechanisms such as a touch-sensitive panel, a keyboard or keypad, and/or a mouse or trackpad, among other possibilities. In some embodiments, the user interface may support voice input, and the electronic device 102 may include or interact with a voice recognition system to facilitate processing of voice input from a user.

The communication interface 210 may include one or more components to facilitate communicating with other electronic devices 102, with the media content server 104, with the CDN 106, with associated media presentation systems, and/or with other devices and/or systems. For instance, the communication interface 210 may include one or more wireless communication interfaces 260 configured to facilitate direct or networked communication according to any of various wireless communication protocols, such as those noted above, among others. In addition or alternatively, the communication interface 210 may include one or more wired communication interfaces supporting direct or networked communication according to any of various wired communication protocols, such as HDMI, Universal Serial Bus (USB), THUNDERBOLT, and/or Ethernet, among others.

The non-transitory data storage 212 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 202 or may be provided separately. As further shown, the data storage 212 may store program instructions, which may be executable by the processor 202 to carry out various electronic device operations.

These instructions may define programs, modules, and/or data structures, such as but not limited to an operating system 216, a communication module 218, a user interface module 220, a media application 222, a web browser application 234, and one/or more other applications 236. Further, these instructions may be structured as separate software programs, procedures, modules, or the like, and/or may be combined together and/or otherwise arranged in various embodiments.

The operating system 216 may define procedures for handling various basic system services and for performing hardware-dependent tasks. The communication module 218 may define procedures supporting connection and communication with other computing devices and systems (e.g., with the media content server 104, the CDN 106, with various media presentation systems, and/or with other electronic devices 102) through the communication interface 210 and possibly the one or more networks 112. And the user interface module 220 may define procedures supporting use of the user interface 204, such as to receive commands and/or other input from a user and to provide media playback and other output to the user.

In line with the discussion above, the media application 222 may be a program application configured to access a media-providing service of a media-content provider associated with the media content server 104 for instance, and may be configured to support requesting, receiving, processing, and presenting of media content items. In some implementations, the media application 222 may include a media-player, a streaming-media application, and/or any other appropriate application or component to facilitate retrieval and/or receipt of media content and playing of the media content. Further, the media application 222 may define various logic modules, such as a playlist module 224, a recommender module 226, and/or a content-items module 228.

The playlist module 224 may store sets of media items for playback in a predefined order. Further, the playlist module 224 may be configured to generate playlists. In some embodiments, the playlist module 224 may include a diffusion-model component, a large-language-model component, and/or a nearest-neighbor-search component, among other possibilities. The recommender module 226 may be configured to identify and/or display recommended media content items (e.g., for inclusion in a playlist). The recommender module 226 may likewise include a diffusion-model component, a large-language-model component, and/or a nearest-neighbor-search component, among other possibilities. The content-items module 228 may be configured to store media content items, including audio items such as songs, podcasts, and audiobooks, for playback, and to provide requests for media content items to the media content server 104. In some implementations, the content-items module 228 may include or otherwise have access to a set of vector representations for the media content items.

The web browser application 234 may be configured to support user access, viewing, and interaction with web sites. To facilitate this, the web browser application 234 may be configured to use standard web-based communication protocols, web-based applications, and/or web-based content formats and/or may be configured to use proprietary protocols, applications, and formats.

The other applications 236 in the non-transitory data storage 212 of the electronic device 102 may then include any of a variety of additional applications, supporting operations such as word processing, calendaring, mapping, weather, time keeping, virtual digital assistant, presenting, drawing, instant messaging, e-mail, telephony, video conferencing, photo management, video management, music playing, video playing, 2D gaming, 3D (e.g., virtual reality) gaming, electronic book reading, and/or workout management, among other possibilities.

The example electronic device 102 may also include one or more sensors (not shown) such as accelerometers, gyroscopes, compasses, magnetometer, light sensors, near field communication transceivers, barometers, humidity sensors, temperature sensors, proximity sensors, range finders, and/or other devices for sensing and measuring various operational, environmental and/or other conditions, among possibly other components.

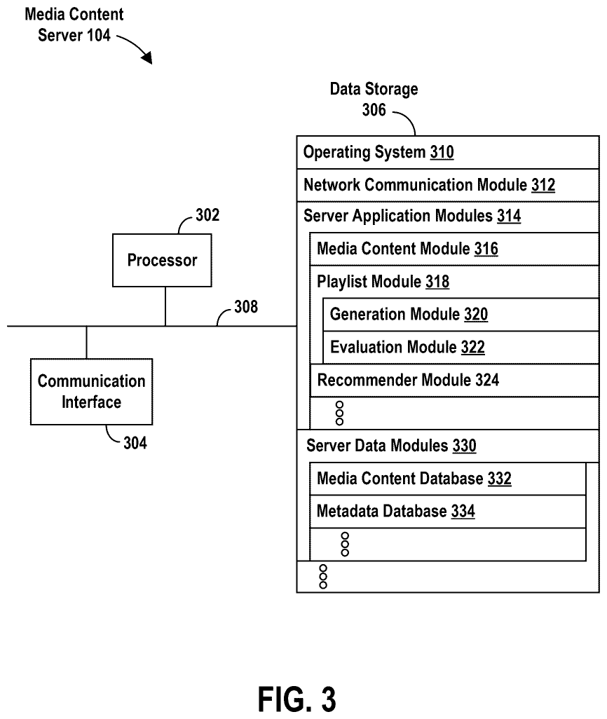

FIG. 3 is next a simplified block diagram of an example media content server 104. As shown in FIG. 3, the example media content server 104 includes a processor 302, a communication interface 304, and non-transitory data storage 306, any or all of which may be integrated together to various extents and/or communicatively linked with each other by a system bus, network, or other connection mechanism 308, on a chipset or other integrated circuit, among other possibilities.

The processor 302 may include one or more general purpose processors (e.g., microprocessors) and/or one or more specialized processors (e.g., DSPs, GPUs, NPUs, etc.)

The communication interface 304 may comprise a network communication interface to facilitate communicating with the electronic devices 102, with the CDN 106, and/or with other devices and/or systems, through the one or more networks 112 and/or other channels. For instance, the communication interface 304 may include a wired and/or wireless Ethernet communication module, among other possibilities.

The non-transitory data storage 306 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 302 or may be provided separately. As further shown, the data storage 306 may store program instructions, which may be executable by the processor 302 to carry out various media-content-server operations.

These instructions may define programs, modules, and/or data structures, such as but not limited to an operating system 310, a network communication module 312, one or more server application modules 314, and one or more server data modules 330. Further, these instructions may be structured as separate software programs, procedures, modules, or the like, and/or may be combined together and/or otherwise arranged in various embodiments.

The operating system 310 may define procedures for handling various basic system services and for performing hardware-dependent tasks. And the communication module 312 may define procedures supporting connection and communication with other computing devices and systems, such as with the electronic devices 102 and the CDN 106, through the communication interface 304 and possibly through the one or more networks 112 or other channels.

The one or more server application modules 314 may define procedures supporting providing and managing a content service. These server application modules 314 may include a media content module 316, a playlist module 318, and/or a recommender module 324, among other possibilities.

The media content module 316 may store and/or otherwise have access to media content items and may be configured to send (e.g., stream and/or progressively transmit) the media content items to the electronic devices 102. The playlist module 318 may store and/or otherwise have access to data defining sequences or other sets of media content items and may be configured to send those playlists to the electronic devices 102. The playlist module 318 may include a generation module 320 for generating playlists and media sets, and an evaluation module 322 for evaluating the playlists and media sets, e.g., before and after publication. Further, the playlist module 318 may include a diffusion-model component, a large-language-model component, and/or a nearest-neighbor-search component, among other possibilities.

The recommender module 324 may determine and/or provide media-content-item recommendations (e.g., for a playlist). In some embodiments, the recommender module 324 also includes a diffusion-model component, a large-language-model component, and/or a nearest neighbor-search component, among other possibilities.

The one or more server data modules 330 may manage the storage of and/or access to media items and/or metadata relating to media content items. As such, the one or more server data modules 330 may include a media content database 332 for storing media items and/or vector representations (e.g., vector embeddings) of the media content items, and a metadata database 334 for storing metadata relating to the media content items, such as genre, artist, and other information associated with the respective media content items.

The media content server 104 may also include a web server such as a Hypertext Transfer Protocol (HTTP) servers, File Transfer Protocol (FTP) servers, and may maintain or otherwise have access to web pages and other content defined with Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

The description of the media content server 104 as a “server” is intended as a functional description of the devices, systems, processor cores, and/or other components that provide the functionality attributed to the media content server 104. It will be understood that the media content server 104 may be a single server computer, or may comprise multiple server computers. Moreover, the media content server 104 may be coupled with CDN 106 and/or other servers and/or server systems, or other devices, such as other client devices, databases, content delivery networks (e.g., peer-to-peer networks), network caches, and the like. Further, in some embodiments, the media content server 104 may be implemented by multiple computing devices working together to perform the actions of a server system, such as to provide cloud-based server or cloud-computing service.

### Digital Audio Content and Streaming

Digital audio content may encompass a broad range of audio data that has been converted into a digital format, enabling it to be stored, processed, transmitted, and received by electronic devices. By way of example, digital audio content could include songs and other music, as well as spoken word recordings such as news broadcasts, podcasts, audiobooks, that offer listeners a convenient way to consume information and entertainment through auditory means. Further, digital audio content could combine spoken word with music or other sounds, creating rich, multi-layered audio experiences suitable for radio shows, multimedia presentations, and enhanced podcasts. And still further, digital audio content could constitute the audio portion of multimedia video content (e.g., of H.264/MPEG-4 or 3GP encoded content), such as the soundtrack of a movie, television show, online video, or live stream, among many other possibilities.

Digital audio content represents analog audio content as a sequence of digital information such as bits representing sequential frames of the analog audio. Digital audio content may be compressed or otherwise encoded using various encoding techniques (e.g., MP3, AAC, or Opus) to help reduce file size while maintaining quality and to help facilitate distribution of the audio through various techniques such as streaming, progressive downloading, bulk file transfer, or broadcasting, for instance.

Digital audio streaming involves transmitting a digital audio stream from a content source (e.g. media content server 104 or CDN 106) to an electronic device 102, typically over a network 112, for real-time playout of the audio by the electronic device 102 as the electronic device 102 receives the transmission. A variation of audio streaming is progressive downloading, where an electronic device 102 downloads a digital audio file in pieces and plays out the audio file before the entire download is finished. One technical difference between streaming and progressive downloading is that, with streaming, the electronic device 102 usually does not maintain a copy of the audio as the electronic device 102 plays it out, whereas with progressive downloading, the electronic device 102 ends up with a downloaded copy of the audio for possible later playout as well.

To prepare digital audio for streaming or other distribution, a computing system such as the media content server 104 may start with a digital audio file that defines a time sequence of digital audio data such as a sequence of audio frames, the computing system may encode the digital audio data of the file using an encoding algorithm to establish a corresponding time sequence of encoded digital audio data, and the computing system may segment the encoded digital audio data into smaller pieces or audio segments, which the computing system may store for transmission. Further, the computing system may generate multiple different encoded versions of the digital audio segments per file, using multiple different levels or types of encoding and compression, to facilitate adaptive switching between versions during transmission.

To facilitate streaming of an audio content item to an electronic device 102, the media content server 104 may employ a streaming protocol such as HTTP Live Streaming (HLS), Dynamic Adaptive Streaming over HTTP (DASH), or Real-Time Messaging Protocol (RTMP) to transmit the audio segments. These protocols manage the data transmission and adapt to varying network conditions. Additionally, the media content server 104 may handle user sessions, managing requests for specific audio streams and providing secure access through authentication and authorization mechanisms. The media content server 104 may also make use of the CDN 106, which may cache the audio content pieces on geographically distributed servers, to help reduce streaming latency and improve reliability and user experience.

On the receiving end, the media application 222 of the electronic device 102 may initiate a connection to the media content server 104 and request streaming of a specific audio content item. As the media application 222 receives the initial audio segments of the requested audio content in response to this request, the media application 222 may then start buffering and pre-loading a portion of the audio in the memory of the electronic device 102 to facilitate smooth playback even in the case of minor network interruptions. Further, the media application 222 may decode the audio pieces in order to uncover the original digital audio data and may convert that digital audio data to a form suitable for output. For instance, the media application 222 may play the decoded audio through an audio output device 206 of the electronic device 102 or through another electronic device 102. Further, the media application 222 may manage playback (e.g., play, pause, skip, and volume adjustment) through associated user-interface controls.

Adaptive streaming protocols such as those discussed above may allow the electronic device 102 to monitor network conditions and request different quality levels of digital audio content based on current bandwidth availability, thus providing consistent playback without interruptions in most cases. Further, the electronic device 102 may handle network errors and interruptions by attempting to reconnect to the media content server 104, by re-buffering when necessary, and by dynamically adjusting the stream quality to maintain a continuous audio experience.

Linking of Podcasts with Other Media Content Items

As noted above, the present disclosure provides a technical mechanism to link media content. Without limitation, the mechanism could be used to link podcasts with other media content items such as audiobooks, songs, videos, or other podcasts, such as by linking podcasts with authors, artists, or other individuals associated with the other media content items. For instance, an example implementation provides for linking a podcast episode with an audiobook author (e.g., an author identifier (such as a universal resource indicator (URI)) and thus with one or more audiobooks by that author, based on a programmatic determination that the author is a guest of the podcast episode. The present disclosure will primarily address that example implementation. However, it will be understood that the disclosed principles could also apply more generally, such as to facilitate linking podcasts with other types of media content items, linking other media content items, and establishing links on other bases.

The example process could be carried out by a computing system that has access to data representing one or more podcast episodes and data representing each of various audiobook authors and associated audiobooks.

For instance the process could be carried out by the media content server 104 and/or a related platform or device, which may have access to the podcast and audiobook data for purposes of making podcasts and audiobooks available for searching by and streaming to electronic devices 102. Alternatively, the process could be carried out by an electronic device that has access to the podcast and audiobook data, possibly having downloaded or otherwise acquired that data in the past. Other computing-system implementations may be possible as well.

Example Computing System with Podcast and Audiobook Data

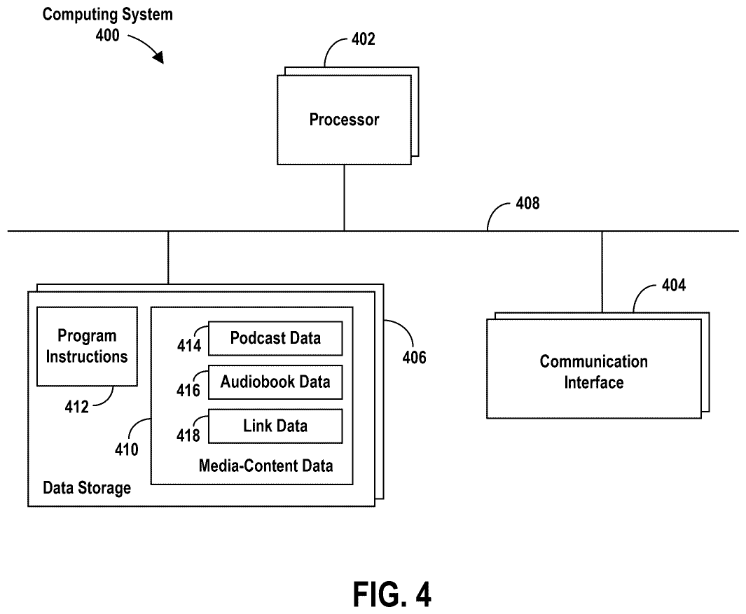

FIG. 4 is a simplified block diagram illustrating an example computing-system arrangement. As shown in FIG. 4, an example computing system 400 includes at least one processor 402, at least one communication interface 404, and non-transitory data storage 406, any or all of which may be integrated together to various extents and/or communicatively linked with each other by a system bus, network, or other connection mechanism 708.

The at least one processor 402 may include one or more general purpose processors (e.g., microprocessors) and/or one or more specialized processors (e.g., DSPs, GPUs, NPUs, etc.) The at least one communication interface 404 may comprise a network communication interface, perhaps a wired and/or wireless communication module, among other possibilities, to facilitate communicating with other entities. And the non-transitory data storage 406 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 402 or may be provided separately and made accessible to the processor 402.

As further shown, the data storage 406 may store media-content data 410 and program instructions 412. The media-content data 410 may comprise podcast data 414, audiobook data 416, and link data 418, and the program instructions 412 may be executable by the at least one processor 402 to carry out various operations described herein with respect to the media-content data 410. In some embodiments, the media-content data 410 and program instructions 412 may be stored in separate instances of data storage 406. Further, in some embodiments, portions of the media-content data 410 may be stored in separate instances of data storage 406.

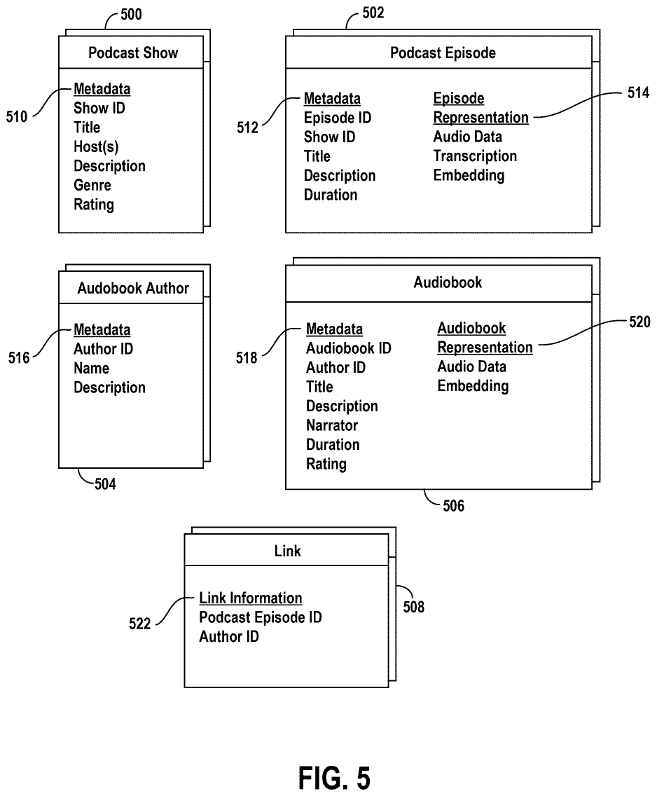

In an example implementation, the media-content data 410 may be structured in a relational-database format with interrelated data records among other possibilities. As shown in FIG. 5, for instance, the podcast data 414 may comprise podcast-show records 500 and interrelated podcast-episode records 502, the audiobook data 416 may comprise audiobook-author records 504 and interrelated audiobook records 506, and the link data 418 may comprise link records 508 providing potentially bidirectional links between podcast episodes and audiobook authors, among other possibilities.

The podcast-show records 500 may comprise a record respectively for each of various podcast shows, each podcast-show record providing podcast-show metadata 510 such as a show identifier (ID), show title, show host(s), show description, show genre, and show rating, among other possibilities.

The podcast-episode records 502 may then comprise a record respectively for each of various podcast episodes, each podcast-episode record providing both podcast-episode metadata 512 and podcast-episode-representation data 514. The podcast-episode metadata 512 may comprise an episode ID, an associated show ID for the show of which the episode is a part, episode title, episode description, and episode duration, among other possibilities. And the podcast-episode-representation data 514 may comprise audio data of the podcast episode, such as encoded audio data suitable for playing and/or streaming, as well as a text transcription of the podcast episode, and derived-representation data such as a vector embedding representing the podcast episode in multidimensional space that may facilitate comparisons and clustering, among other possibilities.

The audiobook-author records 504 may comprise a record respectively for each of various audiobook authors, each audiobook-author record providing author metadata 516 such as an author ID, author name, and author description, among other possibilities.

And the audiobook records 506 may comprise a record respectively for each of various audiobooks, each audiobook record providing both audiobook metadata 518 and audiobook-representation data 520. The audiobook metadata 518 may comprise an audiobook ID, an associated author ID for an author of the audiobook, audiobook title, audiobook description, audiobook narrator name, audiobook duration, audiobook rating, among other possibilities. And the audiobook-representation data 520 may comprise audio data of the audiobook, such as encoded audio data suitable for playing and/or streaming, as well as a text representation (e.g., description) of the audiobook, and derived-representation data such as a vector embedding representing the audiobook in multidimensional space, that may likewise facilitate comparisons and clustering, among other possibilities.

The link records 508 may then comprise link information 522 respectively defining each logical connection established between a podcast episode and an audiobook author and/or between a podcast episode and an audiobook having a particular author. For instance, when the computing system 400 determines that a given podcast episode has a guest that is an audiobook author, the computing system may establish a record that logically relates that podcast episode with that audiobook author and/or with one or more audiobooks of that author, such as by relating a podcast-episode ID with an author ID and/or by relating a podcast-episode ID directly with an audiobook ID.

In an alternative arrangement, the computing system 400 may store in each of one or more podcast-episode records a link to each audiobook author that the computing system 400 has deemed to be a guest of the podcast episode. For instance, the computing system may store in each podcast-episode record a URI defining an address of the associated audiobook-author record.

Note also that the data records described here can take other forms as well. For instance, data or content could be represented in various forms, such as by text, video, audio, or the like, using any of various languages, protocols, and/or other information-representation techniques.

### Example Processing

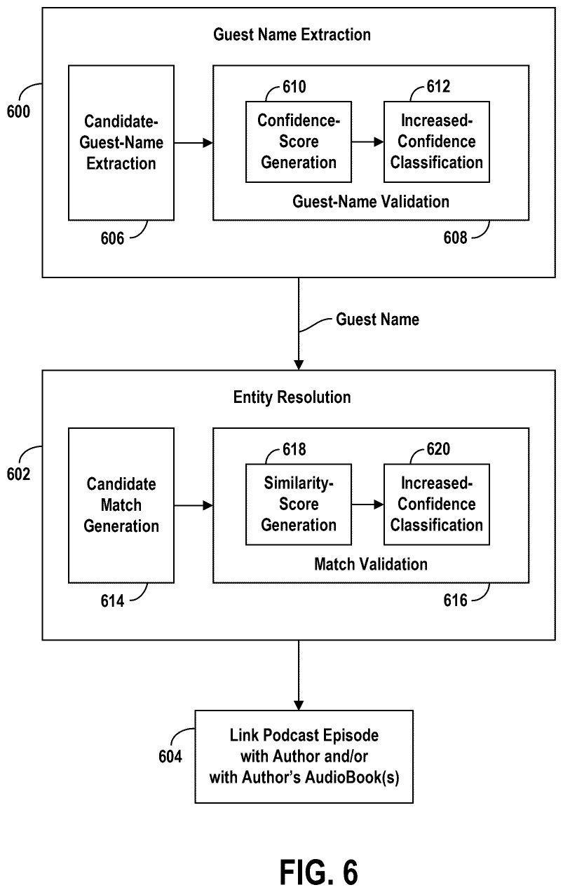

FIG. 6 is a processing-flow diagram illustrating example processing by the computing system 400 to find that a podcast guest is an audiobook author. As shown, the process may comprise two main stages, (i) guest-name extraction 600 and (ii) entity resolution 602. Guest-name extraction 600 may involve determining through machine-analysis the name of a guest of the podcast episode. And entity resolution 602 may then involve determining through machine-analysis that the guest of the podcast episode matches a certain audiobook author. By this processing, the computing system may thereby establish and associate with the podcast episode a link 604 to the audiobook author, which the audiobook data 416 may in turn relate to one or more audiobooks by that author.

### Guest-Name Extraction

In an example implementation as shown in FIG. 6, the guest-name extraction process 600 may itself involve at least two stages of processing, (i) candidate-guest-name extraction 606 and (ii) guest-name validation 608.

As discussed above, candidate-guest-name extraction 606 may involve the computing system 400 recognizing names associated with the podcast episode. This may involve the computing system 400 applying a trained LLM to a transcription of the podcast episode and/or to the podcast metadata, such as by providing as input to the LLM a transcription of the podcast episode and/or its metadata and receiving as output from the LLM one or more names that the LLM predicts to each be associated with the podcast episode. To facilitate this, the LLM could be trained in various ways to recognize names associated with a podcast episode or the like. For instance, this could include named-entity-recognition training, fine tuning the LLM on a data set of text with labeled name entities, among other possibilities.

As to each candidate-guest name, the computing system 400 may then apply guest-name validation 608 to help determine with a sufficient level of confidence whether the candidate guest is indeed the guest of the podcast episode, rather than, say the host of the episode or merely a person mentioned in the episode.

This guest-name validation 608 in the example implementation may also involve at least two stages of processing, (i) confidence-score generation 610 and (ii) increased-confidence classification 612.

The confidence-score generation 610 may involve the computing system 400 applying an LLM, providing as input to the model a set of text of the podcast episode (e.g., a transcript of the episode, the title of the episode, and/or a description of the episode) in combination with the candidate guest name, and receiving as output from the model a prediction of likelihood that the candidate guest name is the name of a guest of the podcast, the prediction defining a confidence score (e.g., a zero-shot probability) indicating level of confidence that the candidate guest name is the name of a guest of the podcast rather than perhaps a host name or merely mentioned in the podcast.

The increased-confidence classification 612 may then involve processing to help establish with higher confidence whether the candidate guest name is indeed the name of a guest of the podcast. As noted above, this may involve application of a further trained ML model, such as a trained random-forest classifier or other ensemble learning method for instance, based on (i) the established confidence score and (ii) a set of features that may be characteristic of whether a name is a guest name as compared with, say, a host or mere mention for instance.

As noted above, this set of features could include one or more show-based features, one or more episode-based features, and/or one or more guest-based features, any or all of which the computing system 400 may determine through consideration of the relational data discussed above and/or based on past analysis.

For instance, show-based features may include length of the show title and description, average number of guests per episode in the show, number of episodes in the show, number of distinct guests in the show. Episode-based features may include length of the episode title and description, and number of distinct guests in the episode. And guest-name features may include number of times a given guest appears in all episodes of the show, whether the guest name is in the episode name, whether the guest name is in the show name, and number of shows with a given guest.

To facilitate this, the random forest classifier could be trained based on a set of example training data including the applicable features that would be used to provide a prediction of whether a given candidate name is a guest name.

By application of this increased-confidence classification 612 based on the established confidence score and the additional characteristic features, the computing system 400 may thus obtain a prediction of level of certainty that a given candidate guest name extracted from the podcast episode data is the name of a guest of the podcast episode. The computing system 400 may then conclude that a given candidate guest name is the name of a guest of the podcast episode by determining that the level of certainty of this prediction is at least as high as a predefined threshold level set to facilitate commercially practical linking of media content items.

Note that, in alternative embodiments, the computing system 400 may determine the name of a guest of the podcast episode in other ways. For instance, the podcast episode metadata may itself expressly specify the name of each of one or more guests of the podcast, in which case the computing system 400 may simply read that guest information from the podcast metadata. Other examples may be possible as well.

Matching of Podcast Guest Name with Audiobook Author Name

For each of one or more such podcast guest names, the computing system 400 may then engage in the entity resolution 602, which as noted above may involve determining that the podcast guest is an audiobook author—so that the computing system can then programmatically associate the podcast episode with that author and/or with one or more audiobooks by that author. As shown in FIG. 6, the entity resolution process 602 may involve at least two stages of processing, (i) candidate match generation 614 and (ii) match validation 616.

As discussed above, the candidate match generation 614 may involve the computing system 400 applying fuzzy-name matching to find one or more known audiobook author names that sufficiently match the guest name (e.g., to find that two names match each other even if they have slight differences, such as due to spelling errors, use of nicknames or other abbreviations, or transliteration differences, for instance). The computing system 400 may engage in this fuzzy-name matching using any of various fuzzy-name-matching techniques, such as but not limited to Levenshtein distance, phonetic matching, and token-based matching. Further, the computing system 400 may apply a trained LLM embedder to carry out this candidate match generation, which may leverage the LLM's semantic understanding and potentially-improved accuracy.

An example fuzzy-name matching process may involve the computing system 400 programmatically comparing the guest name (e.g., as a character string) with each audiobook-author name (e.g., as a character string) in the audiobook-author records 516 and, for each audiobook-author name, establishing a percentage value or other relative term defining a level of similarity between the guest name and the author name.

For instance, the computing system 400 may first normalize each name, such as by using an LLM to strip from the name any title (e.g., “Mr.”, “Ms.”, “Dr.”, etc.) and possibly to identify and label the first, middle, and last names if applicable. Further, the computing system 400 may establish a non-extended version of each name, such as an abbreviated code-based version, and may compare those non-extended versions, and/or the computing system 400 may compare more full, extended versions of each name. The computing system 400 may then compare non-extended (e.g., abbreviated, code-based) or extended versions (e.g., more full-text versions) of the guest name with each author name and may deem an author name to be a candidate match for the guest name based on the computing system 400 finding that their determined level of similarity is at least as high as a predefined threshold level.

As to each candidate match, i.e., as to each of one or more audiobook-author names that the computing system 400 finds to be a candidate match for the podcast-guest name, the computing system 400 may then apply the match validation 616 to help determine with a sufficient level of confidence whether the audiobook-author is a guest of the podcast episode. This analysis may help to justify the computing system 400 establishing a link between the podcast episode and the author and/or directly between the podcast episode and at least one audiobook by that author.

This match validation 616 in the example implementation may also involve at least two stages of processing, (i) similarity-score generation 618 and (ii) increased-confidence classification 620.

The similarity-score generation 618 may involve the computing system 400 determining a level of similarity between the podcast episode and each of one or more audiobooks by the author at issue to help establish a close enough association of the podcast episode with the author. For instance, this may involve the computing system 400 identifying a set of one or more audiobooks by the author (e.g., up to ten such audiobooks), determining for each identified audiobook an embedding similarity between the audiobook description and the podcast episode description, and evaluating the results.

By way of example, the computing system 400 may refer to the audiobook data 416 to identify each of one or more audiobooks by the author and obtain the description of each identified audiobook, and the computing system 400 may refer to the podcast data 414 to obtain the description of the podcast episode. Further, the computing system 400 may remove extraneous text (e.g., HTML tags, etc.) from each description, and the computing system 400 may apply a deep learning model to each description to establish a vector embedding respectively of the description. For instance, the computing system 400 may use an LLM to embed each description into a respective multi-dimensional vector. For each audiobook, the computing system 400 may then compute an embedding similarity between the podcast-episode-description embedding and the audiobook-description embedding, such as by computing a Euclidean distance, cosine similarity, or dot product of the embedding vectors. Further, for the set of one or more audiobooks in this analysis, the computing system 400 may then compute one or more representative similarity measures, such as a minimum similarity, a mean similarity, and a maximum similarity.

The increased-confidence classification 620 may then involve processing to help establish with higher confidence whether a candidate match is correct, i.e., whether a given audiobook author is a guest on the podcast episode. As noted above, this may involve application of a further trained ML model, such as a random-forest classifier or other ensemble learning method for instance, based on (i) the established similarity score, perhaps multiple similarity measures as noted above, possibly along with a level of certainty of the similarity score as discussed above, and (ii) a set of features that may be characteristic of whether an author name is indeed the name of a guest of the podcast episode.

As to the similarity score, the computing system 400 may establish a level of certainty, or exactness, of the similarity, such as based on a frequency of occurrence of a keyword on which a candidate match was found. A theory here is that candidate matches based on popular fuzzy-names such as “johnsmith” may be less likely to be correct. The computing system 400 may then weigh the similarity based on this established level of certainty.

This set of features that may be characteristic of whether an author name is indeed the name of a guest of the podcast episode could then include one or more keyword-based features, one or more podcast-show-based features, and one or more author-based features, among other possibilities, any or all of which the computing system 400 may determine through consideration of the relational data discussed above and/or based on past analysis.

For instance, keyword-based features may include whether the episode description includes a mention of any of the candidate author's books, the word “book” generally, and/or a mention of an online platform where the author's book could be purchased or otherwise acquired. Show-based features, as to the podcast show of which the episode is a part, may include the average number of extracted guest names per episode of the show, a fraction of episodes of the show that contain the word “author” or “authored”, the number of episodes in the show, a fraction of extracted guest names having at least one fuzzy-name determined candidate matching author name across all episodes of the show, an average number of candidate matches of guest name with author name per episode of the show, a total number of guests across all episodes of the show, and a distinct number of guest names across all episodes of the show. And author-based features may include the number of audiobooks the author has attributed to them, possibly capped at a maximum number such as ten, possibly limited to include just audiobooks that have a threshold high level of popularity (e.g., per user reviews) and/or are threshold recent, among other possibilities, and whether the author writes fiction or rather non-fiction.

To facilitate this, the random forest classifier could be trained based on a set of example training data including the applicable features that would be used to provide a prediction of whether a given candidate match is correct, e.g., whether a given audiobook-author identifier and/or content associated with the audiobook-author identifier indeed should be linked to the podcast episode based on the extracted podcast-episode guest name.

By application of this increased-confidence classification 618 based on the established similarity score and the additional characteristic features, the computing system 400 may thus obtain a prediction of level of certainty that a given candidate match of the guest name with an author name is correct. The computing system 400 may then conclude that a given audiobook author is a guest of the podcast episode, by determining that the level of certainty of this prediction is at least as high as a predefined threshold level set to facilitate commercially practical linking of media content items.

Once the computing system 400 has determined through this or similar processing that a particular audiobook author is a guest of the podcast episode, the computing system may establish a link between the podcast episode and the author and/or more directly between the podcast episode and one or more of the author's audiobooks. By way of example, the computing system 400 may update the link data 418 to record a link between the podcast episode ID and the audiobook-author ID. Alternatively or additionally, the computing system 400 may update the podcast-episode metadata 512 to include a URI pointing to the author's audiobook-author record 516 and/or to an audiobook record 518 of one of the podcast' author's audiobooks, and/or the computing system 400 may update the author's audiobook-author record 516 and/or each audiobook record 518 for an audiobook by the author to include a URI pointing to the podcast episode, among other possibilities.

Based on this established link, the media application 222 on an electronic device 102 may then be made to provide a link that would conveniently facilitate navigation between the podcast episode and the audiobook author, and/or between the podcast episode and one or more of the author. For instance, when the media application 222 presents on the device 102 a GUI with information about the podcast episode, possibly with play controls to facilitate playing the podcast episode, the media application 222 may include in that GUI a graphical object such as text or a button that a user of the device 102 can engage to directly navigate to information about the author and/or directly to one or more audiobooks by the author. By way of example, the media content server 104 could generate this GUI and provide the GUI to the device 102 to facilitate presentation. Alternatively, the media application 222 may itself add to the GUI the associated navigation object.

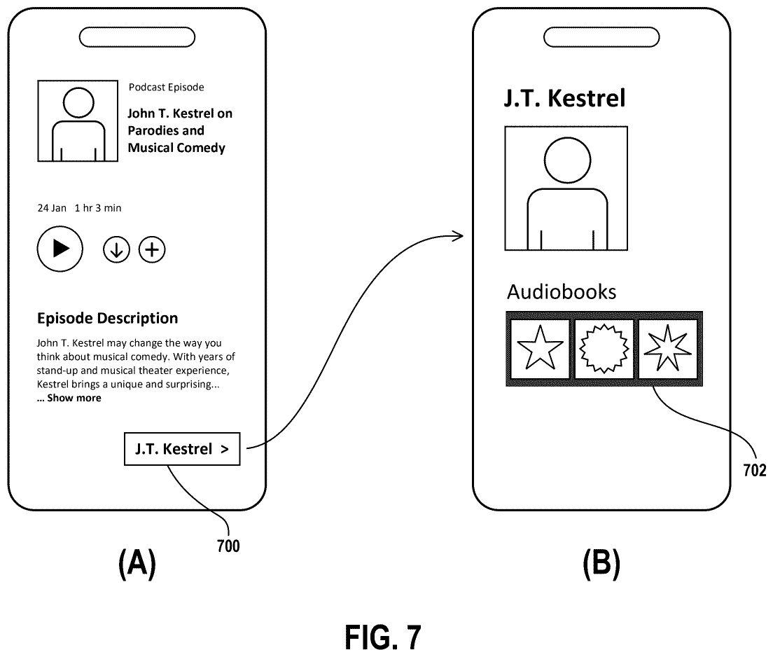

FIG. 7 illustrates in simplified form how such a GUI may appear on a display of the device 102 for a podcast episode having as a guest the audiobook author J. T. Kestrel. As shown in FIG. 7, part A, the GUI includes a podcast episode title and an associated image, a podcast episode description, and a play control to facilitate playing the podcast episode. Further, the GUI includes a navigation link 700 having the text “J. T. Kestrel.” As shown further in part B, when a user of the device 102 engages this navigation link 700, the device may then present links 702 to audiobooks having J. T. Kestrel as author, thus conveniently enabling the user to navigate from the podcast episode to any of those audiobooks. This navigation may enable the user to conveniently access, purchase, or otherwise engage in interaction related to the audiobooks.

As noted above, the principles discussed in this disclosure are not limited to application in the context of audiobook-podcast linking but may more generally apply to linking any of various forms of media content items. Further, as to establishing a link from a podcast, the principles are not limited to basing the linking on a podcast guest name but may extend more generally to basing the linking on any extracted or otherwise obtained key term. Still further, although the above description has discussed establishing links from podcasts to audiobooks, it will be understood that similar principles can apply to linking of audiobooks to podcasts. Yet further, the principles can extend to establishing links between podcasts and non-audio books, such as links to paper books or electronic books, which may include providing a link to a store, library, or other source of such a book. Other variations may be possible as well.

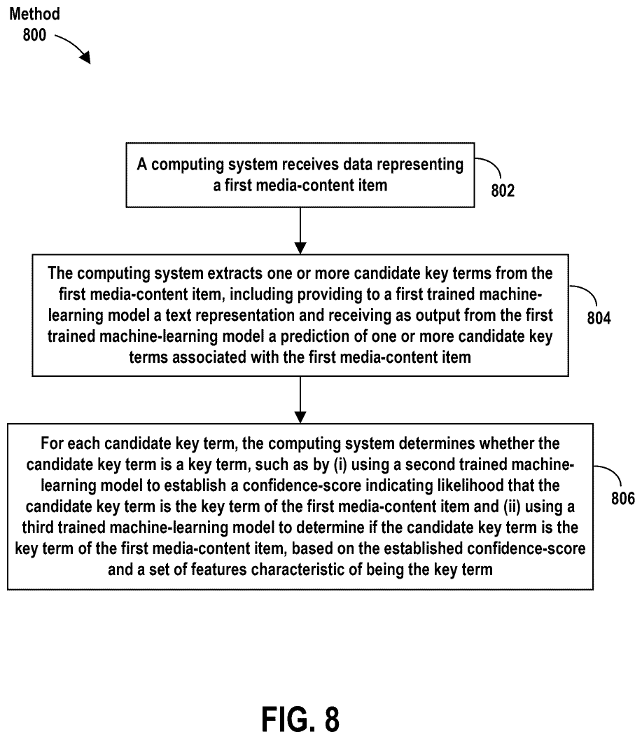

FIG. 8 is a flow chart illustrating a method 800 that can be carried out by a computing system to extract a key term from a first media-content item.

As shown in FIG. 8, at block 802, the method includes a computing system receiving data representing a first media-content item (e.g., podcast episode). At block 804, the method then includes the computing system extracting one or more candidate key terms (e.g., candidate guest names) from the first media-content item, including providing to a first trained ML model (e.g., LLM) a text representation (e.g., transcription and/or description) of the first media-content item episode and receiving as output from the first trained ML model a prediction of one or more candidate key terms associated with the first media-content item.

Further, at block 806, the method includes, for each candidate key term, the computing system determining whether the candidate key term is a key term (e.g., determining whether a candidate guest name as to a podcast episode is actually a name of a guest of the podcast episode), such as by (i) using a second trained ML model (e.g., LLM) to establish a confidence-score indicating likelihood that the candidate key term is the key term of the first media-content item and (ii) using a third trained ML model to determine if the candidate key term is the key term of the first media-content item, based on the established confidence-score and a set of features characteristic of being the key term. Here, the third trained ML model could be a random-forest ML model, and the set of features characteristic of being the key term could take various forms as discussed above for instance.

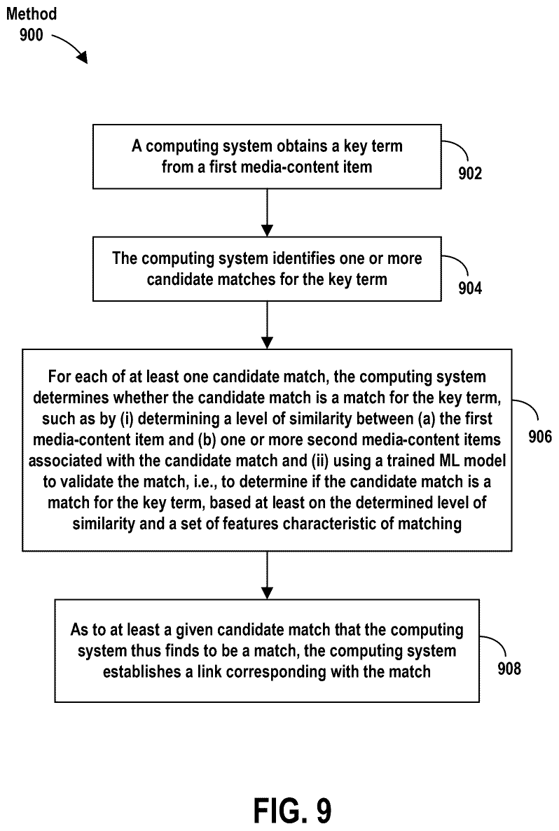

FIG. 9 is next a flow chart illustrating a method 900 that can be carried out by a computing system to dynamically link a first media-content item with a second media-content item.

As shown in FIG. 9, at block 902, the method includes a computing system obtaining a key term (e.g., guest name) from a first media-content item (e.g., podcast episode). For instance, obtaining this key term could involve the method of FIG. 8, and/or could take other forms, possibly including simply reading or otherwise retrieving the key term.

At block 904, the method then includes the computing system identifying one or more candidate matches for the key term (e.g., one or more audiobook authors that may match a podcast-episode guest name). For instance, this may involve first normalizing the data (e.g., normalizing names by removing titles and identifying name parts) and then applying fuzzy-name matching to find one or more candidate matches for the key term.

At block 906, the method then involves, for each of at least one candidate match, the computing system determining whether the candidate match is a match for the key term (e.g., determining whether an audiobook author name found to possibly be a match for a podcast-episode guest name is a match for the guest name), such as by (i) determining a level of similarity between (a) the first media-content item and (b) one or more second media-content items associated with the candidate match and (ii) using a trained ML model to validate the match, i.e., to determine if the candidate match is a match for the key term, based at least on the determined level of similarity and a set of features characteristic of matching. This trained ML model could be a random-forest ML model, and the set of features characteristic of being the key term could take various forms as discussed above for instance.

At block 908, the method then involves, as to at least a given candidate match that the computing system thus finds to be a match, the computing system establishing a link corresponding with the match.

In line with the discussion above, the act of determining the level of similarity between the first media-content item and one or more second media-content items associated with the candidate match could involve determining a level of similarity between a vector embedding of the first media-content item and a vector embedding respectively of each of one or more second media-content items associated with the candidate match. Further, the method could include establishing these vector embeddings. And the act of determining the level of similarity could involve an operation such as computing a Euclidean distance, computing a cosine similarity, and/or computing a dot product.

In addition, as discussed above for instance, the act of using the trained machine-learning model to validate the candidate match, based on the determined level of similarity and the set of features characteristic of matching, could involve (i) providing as input to the trained machine-learning model the determined level of similarity and the set of features and (ii) receiving, in response from the trained machine-learning model, a prediction that the candidate match is a valid match for the key term. Further, the trained machine-learning model could comprise an ensemble learning method, such as a random-forest classifier for instance.

As further discussed above for instance, the act of establishing the link corresponding with the match could involve (a) establishing a respective link between the first media-content item and each of one or more of the second media-content items associated with the candidate match and/or (b) establishing a link between the first media-content item and a stored identifier representative of the validated candidate match, among other possibilities.

Moreover, as discussed above for instance, the first media-content could comprise a podcast episode, the key term could comprise a guest name of the podcast episode, the candidate match could comprise a candidate identifier representative of an audiobook author, and each of the one or more second media-content items could comprise an audiobook having the audiobook author as an author. In that case, the act of validating of the candidate match comprises validating that the guest name is associated with the candidate identifier representative of an audiobook author. Further, the set of features characteristic of matching could include at least one class such as keyword-based features, podcast-show-based features, and/or author-based features.

As indicated above for instance, the keyword-based features could include at least one feature such as whether a description of the podcast episode includes a mention of any book by the audiobook author, whether the description of the podcast episode includes a mention of the word “book”, and/or whether the description of the podcast episode includes a mention of an online platform where a book by the author can be acquired.

Further, the show-based features could as to a podcast show of which the podcast episode is a part and include at least one feature such as an average number of extracted guest names per episode of the show, a fraction of episodes of the show that contain the word “author” or “authored”, a number of episodes in the show, a fraction of extracted guest names having at least one fuzzy-name-determined candidate matching author name across all episodes of the show, an average number of candidate matches of guest name with author name per episode of the show, a total number of guests across all episodes of the show, and/or a distinct number of guest names across all episodes of the show.

And still further, the author-based features could include at least one feature such as a number of audiobooks attributed to the audiobook author and/or whether the audiobook author writes fiction or rather non-fiction. Moreover, the number of audiobooks attributed to the author could be limited to (i) being up to a predefined threshold quantity, (ii) audiobooks that are predefined threshold recent, and (iii) audiobooks that have at least a predefined threshold level of popularity.

Yet further, as discussed above for instance, the act of establishing the link corresponding with the match could involve establishing a link between the podcast episode and the audiobook author. Alternatively or additionally, the act of establishing the link corresponding with the match could involve establishing a link between the podcast episode and at least one audiobook by the audiobook author.

The present disclosure also contemplates non-transitory data storage (e.g., one or more non-transitory computer-readable medium components (e.g., flash, optical, magnetic, ROM, RAM) (e.g., DRAM, SRAM, or DDRAM), EPROM, and/or EEPROM, and/or other computer-readable media, etc.)) holding program instructions executable by at least one processor of a device to cause a computing system to carry out various operations described herein.

Further, the present disclosure contemplates a computer program comprising a set of program instructions executable by at least one processor of a computing system to carry out (e.g., to cause the computing system to carry out) various operations described herein. In an example implementation, the computer program could further be stored in non-transitory data storage such as that noted above, among other possibilities.

### CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any flow charts, for instance, a step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the claims.

1. A method comprising:
obtaining by a computing system a key term from a first media-content item;
identifying by the computing system one or more candidate matches for the obtained key term;
for at least one identified candidate match, determining by the computing system whether the candidate match is a match for the key term, wherein the determining includes (i) determining a level of similarity between the first media-content item and one or more second media-content items associated with the candidate match and (ii) after determining the level of similarity, validating the candidate match, using a trained machine-learning model, based on at least the determined level of similarity and a set of features characteristic of matching; and
based on the validating of the candidate match, establishing by the computing system a link corresponding with the match.

2. The method of claim 1, wherein determining the level of similarity between the first media-content item and one or more second media-content items associated with the candidate match comprises determining a level of similarity between a vector embedding of the first media-content item and a vector embedding respectively of each of one or more second media-content items associated with the candidate match.

3. The method of claim 1, wherein determining the level of similarity comprises an operation selected from the group consisting of computing a Euclidean distance, computing a cosine similarity, and computing a dot product.

4. The method of claim 1, wherein validating the candidate match, using the trained machine-learning model, based on the determined level of similarity and the set of features characteristic of matching, comprises:
providing as input to the trained machine-learning model the determined level of similarity and the set of features; and
receiving, in response from the trained machine-learning model, a prediction that the candidate match is a valid match for the key term.

5. The method of claim 4, wherein the trained machine-learning model comprises an ensemble learning method.

6. The method of claim 5, wherein the ensemble learning method comprises a random-forest classifier.

7. The method of claim 1, wherein establishing the link corresponding with the match comprises one or more of (a) establishing a respective link between the first media-content item and each of one or more of the second media-content items associated with the candidate match or (b) establishing a link between the first media-content item and a stored identifier representative of the validated candidate match.

8. The method of claim 7, wherein the first media-content item comprises a podcast episode, wherein the key term comprises a guest name of the podcast episode, wherein the candidate match comprises a candidate identifier representative of an audiobook author, and wherein each of the one or more second media-content items comprises an audiobook having the audiobook author as an author.

9. The method of claim 8, wherein the validating of the candidate match comprises validating that the guest name is associated with the candidate identifier representative of an audiobook author.

10. The method of claim 8, wherein the set of features characteristic of matching includes features of at least one class selected from the group consisting of keyword-based features, podcast-show-based features, and author-based features.

11. The method of claim 10, wherein the keyword-based features include at least one of whether a description of the podcast episode includes a mention of any book by the audiobook author, whether the description of the podcast episode includes a mention of the word “book”, or whether the description of the podcast episode includes a mention of an online platform where a book by the author can be acquired.

12. The method of claim 10, wherein the show-based features are as to a podcast show of which the podcast episode is a part and include at least one of an average number of extracted guest names per episode of the show, a fraction of episodes of the show that contain the word “author” or “authored”, a number of episodes in the show, a fraction of extracted guest names having at least one fuzzy-name-determined candidate matching author name across all episodes of the show, an average number of candidate matches of guest name with author name per episode of the show, a total number of guests across all episodes of the show, or a distinct number of guest names across all episodes of the show.

13. The method of claim 10, wherein the author-based features include at least one of a number of audiobooks attributed to the audiobook author or whether the audiobook author writes fiction or rather non-fiction.

14. The method of claim 13, wherein the number of audiobooks attributed to the author is limited to (i) being up to a predefined threshold quantity, (ii) audiobooks that are predefined threshold recent, and (iii) audiobooks that have at least a predefined threshold level of popularity.

15. A computing system comprising:
at least one processor;
non-transitory data storage; and
program instructions stored in the non-transitory data storage and executable by the at least one processor to cause the computing system to carry out operations comprising:
obtaining a key term from a first media-content item,
identifying one or more candidate matches for the obtained key term,
for at least one identified candidate match, determining whether the candidate match is a match for the key term, wherein the determining includes (i) determining a level of similarity between the first media-content item and one or more second media-content items associated with the candidate match and (ii) after determining the level of similarity, validating the candidate match, using a trained machine-learning model, based on at least the determined level of similarity and a set of features characteristic of matching, and
based on the validating of the candidate match, establishing a link corresponding with the match.

16. The computing system of claim 15, wherein determining the level of similarity between the first media-content item and one or more second media-content items associated with the candidate match comprises determining a level of similarity between a vector embedding of the first media-content item and a vector embedding respectively of each of one or more second media-content items associated with the candidate match.

17. The computing system of claim 15, wherein validating the candidate match, using the trained machine-learning model, based on the determined level of similarity and the set of features characteristic of matching, comprises:
providing as input to the trained machine-learning model the determined level of similarity and the set of features; and
receiving, in response from the trained machine-learning model, a prediction that the candidate match is a valid match for the key term.

18. The computing system of claim 15, wherein establishing the link corresponding with the match comprises one or more of (a) establishing a respective link between the first media-content item and each of one or more of the second media-content items associated with the candidate match or (b) establishing a link between the first media-content item and a stored identifier representative of the validated candidate match.

19. The computing system of claim 15, wherein the first media-content item comprises a podcast episode, wherein the key term comprises a guest name of the podcast episode, and wherein the match comprises an audiobook author name matching the guest name.

20. Non-transitory data storage storing program instructions executable by one or more processors to carry out operations comprising:
obtaining a key term from a first media-content item;
identifying one or more candidate matches for the obtained key term;
for at least one identified candidate match, determining whether the candidate match is a match for the key term, wherein the determining includes (i) determining a level of similarity between the first media-content item and one or more second media-content items associated with the candidate match and (ii) after determining the level of similarity, validating the candidate match, using a trained machine-learning model, based on at least the determined level of similarity and a set of features characteristic of matching; and
based on the validating of the candidate match, establishing a link corresponding with the match.
